(19) United States
(12) Patent Application Publication
(10) Pub. No.: US 2026/0070355 A1
(43) Pub. Date: Mar. 12, 2026

(54) ASSISTING TOOL AND RECORDING DEVICE

(71) Applicant: SEIKO EPSON CORPORATION, TOKYO (JP)

(72) Inventor: Kazuhiro NISHIYAMA, SHIOJIRI-SHI (JP)

(21) Appl. No.: 19/318,446

(22) Filed: Sep. 4, 2025

(30) Foreign Application Priority Data
Sep. 6, 2024 (JP) 2024-153791

(51) Int. Cl. B41J 13/10; B25B 33/00; B41J 29/13

(52) U.S. Cl. CPC B41J 13/103; B25B 33/00; B41J 29/13

(57) ABSTRACT

An assisting tool assists a pull-out operation of a cassette configured to be able to advance and retreat in relation to a housing between an accommodated position where the cassette is accommodated in the housing and a pulled-out position where the cassette is pulled out from the housing, and the cassette is formed with a handhold part recessed in a push-in direction opposite to a pull-out direction from a surface intersecting the pull-out direction, and the assisting tool includes a rod part, and a hook part provided at the rod part and engageable with the handhold part.

The present application is based on, and claims priority from JP Application Serial Number 2024-153791, filed Sep. 6, 2024, the disclosure of which is hereby incorporated by reference herein in its entirety.

### BACKGROUND

### 1. Technical Field

The present disclosure relates to an assisting tool and a recording device including the assisting tool.

### 2. Related Art

For example, as disclosed in JP-A-2021-138508, there is an image forming device which is an example of a recording device including a housing, a paper feed cassette which is an example of a cassette, and a paper cassette. The paper feed cassette is configured to be movable between an accommodated position where the paper feed cassette is accommodated in the housing and a pulled-out position where the paper feed cassette is pulled out of the housing. The paper cassette is detachably disposed in the paper feed cassette.

The paper cassette includes a paper tray that stores sheet papers, a handle coupled to the paper tray, and an energizing member that energizes the handle. The handle is configured to be rotatable between a flat posture, which is a posture taken when the paper feed cassette is at the accommodated position, and a stand-up posture, which is a posture taken when the paper feed cassette is at the pulled-out position. The energizing member energizes the handle so that the handle is in the stand-up posture.

JP-A-2021-138508 is an example of the related art.

In the image forming device disclosed in JP-A-2021-138508, when the paper feed cassette is pulled out from the accommodated position to the pulled-out position, the handle changes from the flat posture to the stand-up posture due to the energizing force of the energizing member. This makes it easier to grip the handle and therefore the burden of taking out the paper cassette from the paper feed cassette is reduced.

However, in the above-described image forming device, the paper feed cassette needs to be pulled out from the housing to the pulled-out position in order to change the posture of the handle to the stand-up posture. There is room for improvement with respect to the burden of pulling out the paper feed cassette.

The above-described problem is not limited to the configuration including the paper feed cassette and the paper cassette, and may occur in a configuration including the paper feed cassette and not including the paper cassette.

### SUMMARY

According to an aspect of the present disclosure, there is provided an assisting tool that assists a pull-out operation of a cassette configured to be able to advance and retreat in relation to a housing between an accommodated position where the cassette is accommodated in the housing and a pulled-out position where the cassette is pulled out from the housing, in which the cassette is formed with a handhold part recessed in a direction opposite to a pull-out direction from a surface intersecting the pull-out direction, and the assisting tool includes a rod part, and a hook part provided at the rod part and engageable with the handhold part.

According to another aspect of the present disclosure, there is provided a recording device including a housing, a cassette configured to be able to advance and retreat in relation to the housing between an accommodated position where the cassette is accommodated in the housing and a pulled-out position where the cassette is pulled out from the housing, the cassette being configured to be able to accommodate a plurality of media, a recording unit configured to perform recording on the media conveyed from the cassette, and an assisting tool configured to assist a pull-out operation of the cassette, in which the cassette is formed with a handhold part recessed in a direction opposite to a pull-out direction from a surface intersecting the pull-out direction, and the assisting tool includes a rod part, and a hook part provided in the rod part and engageable with the handhold part.

### BRIEF DESCRIPTION OF THE DRAWINGS

FIG. 1 is a perspective view of a first embodiment of a recording device.

FIG. 2 is a schematic view showing the internal configuration of the recording device.

FIG. 3 is a schematic cross-sectional view of a cassette and an assisting tool.

FIG. 4 is a schematic cross-sectional view of the assisting tool with a pressing part located at a reference position.

FIG. 5 is a schematic cross-sectional view of the assisting tool with the pressing part located at a release position.

FIG. 6 is a schematic cross-sectional view of the assisting tool pulling out the cassette.

FIG. 7 is a schematic cross-sectional view of a second embodiment of the cassette and the assisting tool.

FIG. 8 is a schematic cross-sectional view of the assisting tool engaged with a handhold part.

FIG. 9 is a schematic cross-sectional view of the assisting tool releasing a locked state.

FIG. 10 is a perspective view of a first modification example of the recording device.

FIG. 11 is a perspective view of a second modification example of the recording device.

### DESCRIPTION OF EMBODIMENTS

### First Embodiment

Hereinafter, a first embodiment of an assisting tool and a recording device will be described with reference to the drawings. The recording device is, for example, an inkjet printer that performs recording by ejecting ink, which is an example of a liquid, onto a medium such as a sheet paper, a roll paper, a thermal paper, an envelope, a postcard, or a plastic sheet.

In the drawings, assuming that a recording device 11 is placed on a horizontal plane, the direction of gravity is represented by a Z axis, and directions along the horizontal plane are represented by an X axis and a Y axis. The X axis, the Y axis, and the Z axis are orthogonal to each other. In the description below, the X-axis direction is also referred to as a width direction X, the Y-axis direction is also referred to as a depth direction Y, and the Z-axis direction is also referred to as a vertical direction Z.

### Recording Device

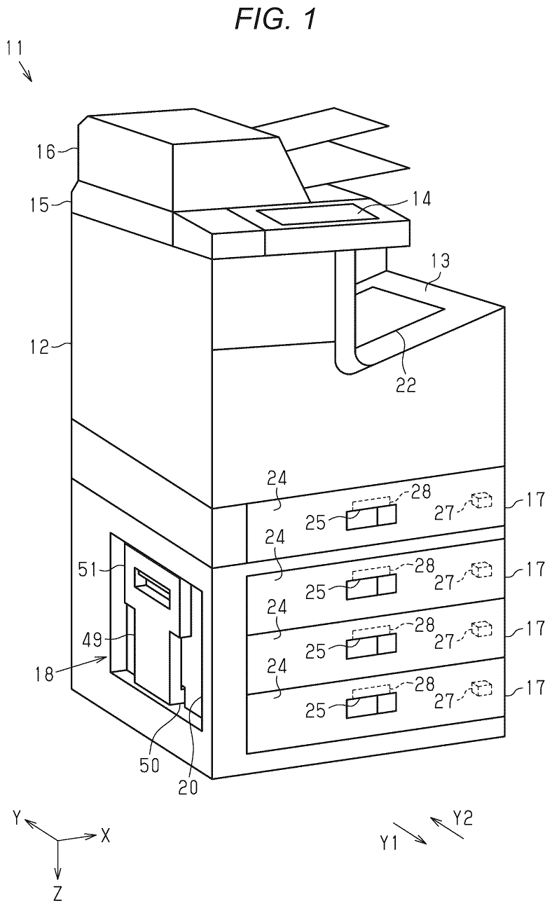

As illustrated in FIG. 1, the recording device 11 may include a housing 12, a stacker 13, an operation panel 14, an image reading unit 15, an automatic feeding unit 16, a cassette 17, and an assisting tool 18.

The housing 12 accommodates various components of the recording device 11. The housing 12 may include an accommodation part 20. The accommodation part 20 stores the assisting tool 18. The accommodation part 20 is, for example, a recess provided at a lateral side of the housing 12.

The stacker 13 receives a discharged medium 22. On the stacker 13, a plurality of recorded media 22 can be stacked. The operation panel 14 is, for example, a touch panel for operating the recording device 11. The operation panel 14 may be provided facing the front of the recording device 11. The image reading unit 15 reads an image of a document. The automatic feeding unit 16 feeds the document to the image reading unit 15.

The recording device 11 may include a plurality of cassettes 17. The plurality of cassettes 17 may be provided, lined up in the vertical direction Z. The recording device 11 according to the present embodiment includes four cassettes 17. The plurality of cassettes 17 have the same configuration. Therefore, one cassette 17 will be described, and the other cassettes 17 will be denoted by the same reference numeral and a repeated description thereof will be omitted.

The cassette 17 can store the medium 22. When the medium 22 is a sheet paper, the cassette 17 may accommodate a bundle of the media 22 before recording. The cassette 17 is, for example, a paper feed cassette. The cassette 17 is provided so as to be able to advance and retreat in relation to the housing 12 between an accommodated position illustrated in FIG. 1 and a pulled-out position, not illustrated. The accommodated position is a position where the cassette is accommodated in the housing 12. The pulled-out position is a position where the cassette is pulled out from the housing 12.

The user performs a pull-out operation on the cassette 17 located at the accommodated position and thus moves the cassette 17 to the pulled-out position. In the pull-out operation, the user pulls out the cassette 17 in a pull-out direction Y1 from the front of the recording device 11. The user performs a push-in operation on the cassette 17 located at the pulled-out position and thus moves the cassette 17 to the accommodated position. In the push-in operation, the user pushes the cassette 17 in a push-in direction Y2 opposite to the pull-out direction Y1. The pull-out direction Y1 and the push-in direction Y2 in the present embodiment are directions parallel to the Y axis.

The cassette 17 has a front surface 24. The front surface 24 is a surface intersecting the pull-out direction Y1 and facing the front. A handhold part 25 is formed in the cassette 17. The handhold part 25 is provided at the front surface 24. The handhold part 25 opens in the front surface 24. The handhold part 25 is recessed from the front surface 24 in the push-in direction Y2.

The cassette 17 may include a lock part 27 and a release lever 28. The lock part 27 restricts the movement of the cassette 17 located at the accommodated position. The lock part 27 may be engaged, for example, with the housing 12. In the present embodiment, a state where the movement from the accommodated position is restricted is also referred to as a locked state. The release lever 28 may be provided at the handhold part 25. Specifically, the release lever 28 may be provided behind the front surface 24 and above the opening of the handhold part 25. The user pulls the release lever 28 in the pull-out direction Y1 and thus can release the engagement between the lock part 27 and, for example, the housing 12. The release lever 28 is a lever for releasing the locked state of the cassette 17.

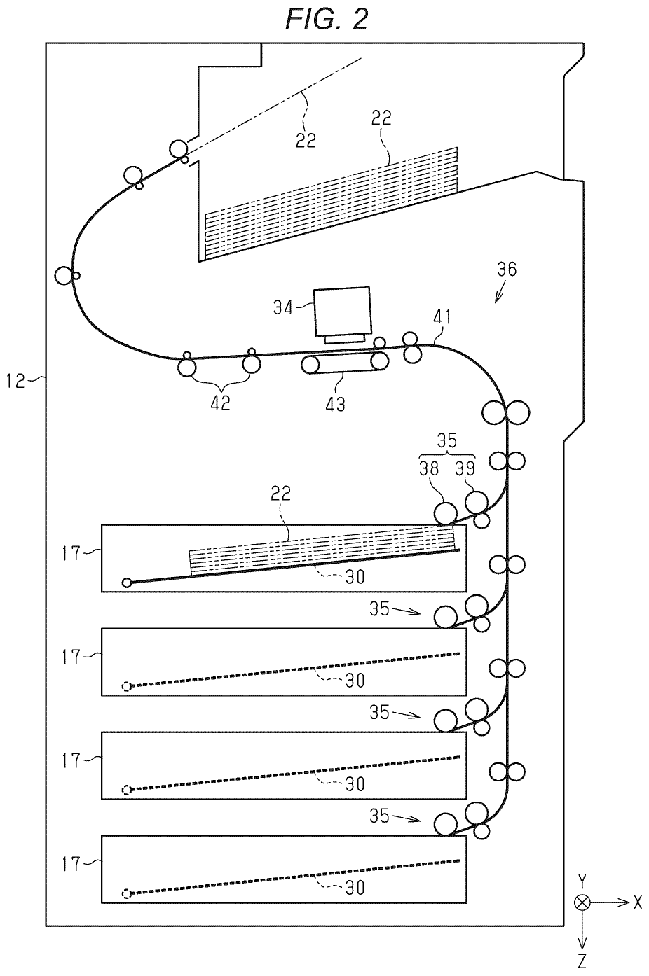

As shown in FIG. 2, the cassette 17 may include a hopper 30. The cassette 17 may be able to accommodate a plurality of media 22 in a stacked state. The hopper 30 pushes up the stacked media 22.

As illustrated in FIG. 2, the recording device 11 may include a recording unit 34, a feeding unit 35, and a conveyance unit 36.

The recording unit 34 ejects a liquid from a nozzle, not illustrated, and thus performs recording on the conveyed medium 22. The recording unit 34 may be a line head that performs recording on the conveyed medium 22 in a stopped state. The recording unit 34 performs recording on the medium 22 conveyed from the cassette 17.

The recording device 11 may include the same number of feeding units 35 as the cassettes 17. The feeding unit 35 feeds the medium 22 stored in corresponding cassette 17 from this cassette 17. The term feeding means to feed, one by one, the media 22 stacked in the cassette 17. The feeding unit 35 may include a feeding roller 38 and a separation unit 39.

The feeding roller 38 comes into contact with the medium 22 from above and thus sandwiches the medium 22 with the hopper 30. The feeding roller 38 rotates in a state of being in contact with the medium 22 and thus feeds the medium 22 to the separation unit 39. When the plurality of media 22 are fed in a stacked state, the separation unit 39 separates the plurality of media 22.

The conveyance unit 36 conveys the medium 22 along a conveyance path 41. The conveyance unit 36 may include one or more roller pairs 42 and a conveying belt 43. The roller pair 42 rotates in a state of sandwiching the medium 22 and thus conveys the medium 22. The conveying belt 43 is an annular belt. The conveyance belt 43 goes around, for example, in a state of supporting the medium 22 by electrostatic chucking, and thus conveys the medium 22.

### Assisting Tool

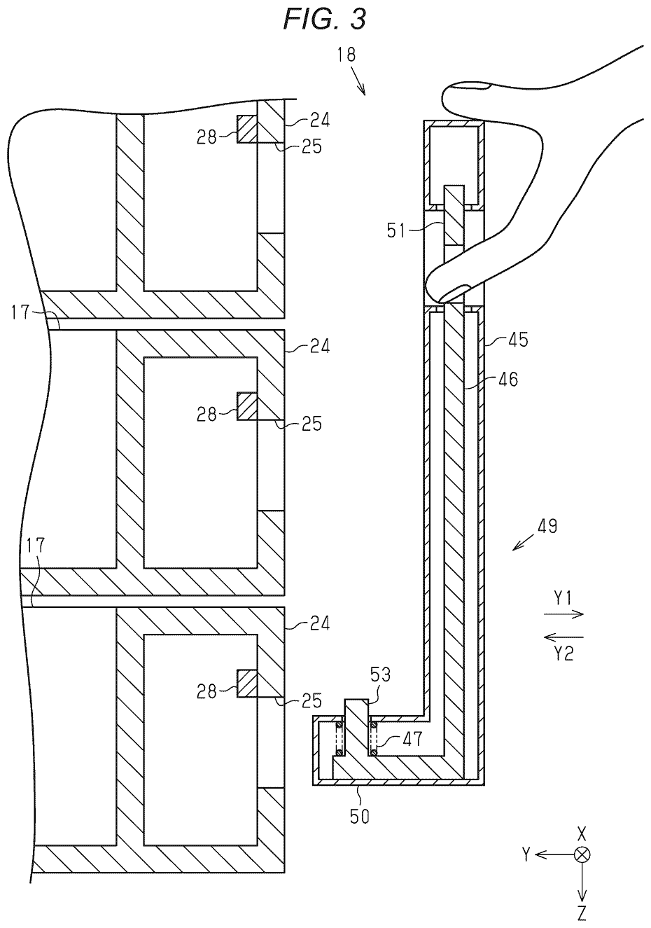

As shown in FIG. 3, the assisting tool 18 may include a frame 45, an operation part 46, and a spring 47. The frame 45 accommodates the operation part 46 and the spring 47.

The assisting tool 18 may include a rod part 49, a hook part 50, and an operation lever 51.

The rod part 49 may be formed by the frame 45. The rod part 49 has a rod shape and extends straight, for example. The rod part 49 may be curved. In the vertical direction Z, the length of the rod part 49 in an engagement posture illustrated in FIG. 3 may be longer than that of the cassette 17. In the present embodiment, the rod part 49 is a part that couples the operation lever 51 and the hook part 50.

The operation lever 51 and the hook part 50 are provided at the rod part 49. The operation lever 51 and the hook part 50 are provided away from each other. The hook part 50 may be located at one end of the rod part 49. The operation lever 51 may be located at the other end of the rod part 49. The operation lever 51 may be formed by the frame 45 and the operation part 46. In the engagement posture shown in FIG. 3, the hook part 50 may be located at the lower end of the rod part 49, and the operation lever 51 may be located at the upper end of the rod part 49.

The hook part 50 may formed by the frame 45 and the operation part 46. The hook part 50 is smaller in size in the width direction X and the vertical direction Z than the opening of the handhold part 25. Therefore, the hook part 50 is engageable with the handhold part 25. The hook part 50 is inserted in the push-in direction Y2 from the opening of the handhold part 25.

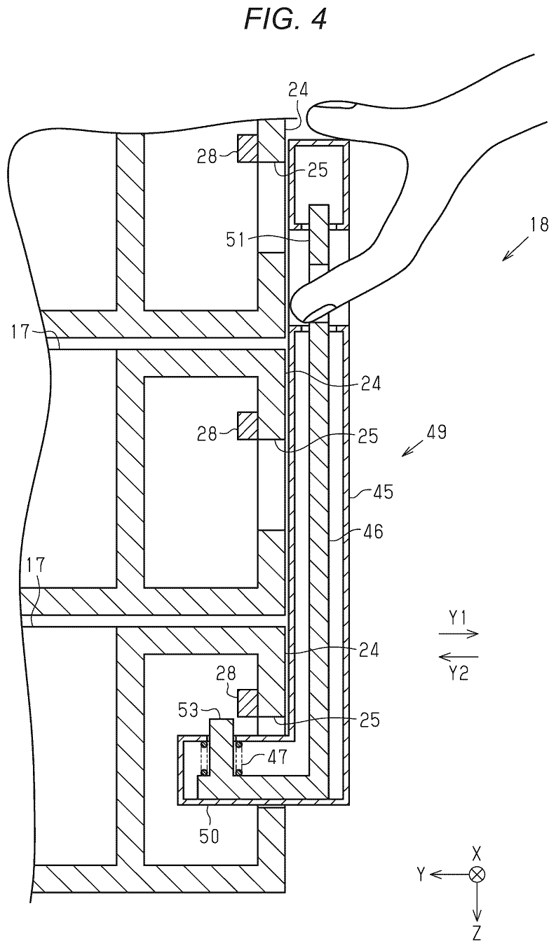

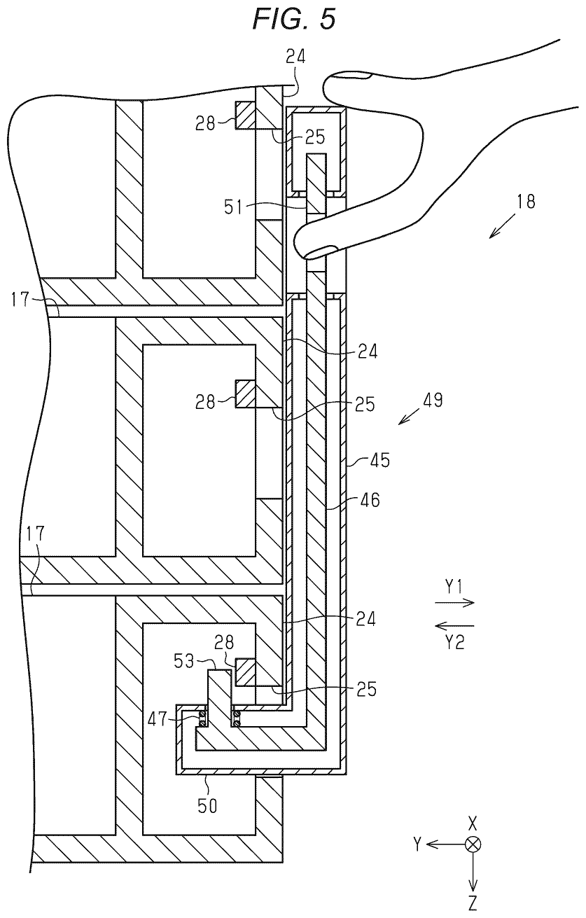

As shown in FIGS. 4 and 5, the hook part 50 may have a pressing part 53. The pressing part 53 may be formed by the operation part 46. The pressing part 53 is movable to a reference position illustrated in FIG. 4 and a release position illustrated in FIG. 5 in a state where the hook part 50 is engaged with the handhold part 25. The reference position is a position where the pressing part 53 does not press the release lever 28. The release position is a position where the pressing part 53 presses the release lever 28.

The spring 47 energizes the pressing part 53 located at the release position toward the reference position. The spring 47 is, for example, a compression coil spring. The spring 47 may press the operation part 46 against the frame 45.

### Functions of First Embodiment

The functions of the present embodiment will be described.

The user places a hand on the handhold part 25 and pulls the release lever 28 in the pull-out direction Y1, and thus can pull out the cassette 17. For example, when pulling out the cassette 17 located below, the user needs to perform the pull-out operation in a crouching posture, and this is a heavy burden particularly on a user in a wheelchair. The user may pull out the cassette 17, using the assisting tool 18.

The assisting tool 18 assists the pull-out operation of the cassette 17. The assisting tool 18 may assist the pull-out operation for each of the plurality of cassettes 17. The hook part 50 is engageable with the handhold part 25 of each of the plurality of cassettes 17. Specifically, when one cassette 17 of the plurality of cassettes 17 is referred to as a first cassette, the hook part 50 is engageable with a first handhold part, which is the handhold part 25 of the first cassette. When one cassette 17 different from the first cassette, of the plurality of cassettes 17, is referred to as a second cassette, the hook part 50 is engageable with a second handhold part, which is the handhold part 25 of the second cassette.

As shown in FIGS. 3 and 4, the assisting tool 18 is engaged with the handhold part 25 in the engagement posture. The assisting tool 18 is inserted into the handhold part 25 with the pressing part 53 located at the reference position.

As shown in FIG. 4, the pressing part 53 located at the reference position is located below the release lever 28. Therefore, when the assisting tool 18 is pulled in the pull-out direction Y1 in the state where the pressing part 53 is located at the reference position, the pressing part 53 does not come into contact with the release lever 28, and the assisting tool 18 is detached from the handhold part 25.

As shown in FIG. 5, the operation lever 51 moves the pressing part 53. When the user grips the operation lever 51 and raises the operation part 46, the pressing part 53 moves to the release position against the energizing force of the spring 47. The pressing part 53 located at the release position overlaps the release lever 28 in the vertical direction Z. Therefore, when the assisting tool 18 is pulled in the pull-out direction Y1 in the state where the pressing part 53 is located at the release position, the pressing part 53 comes into contact with the release lever 28.

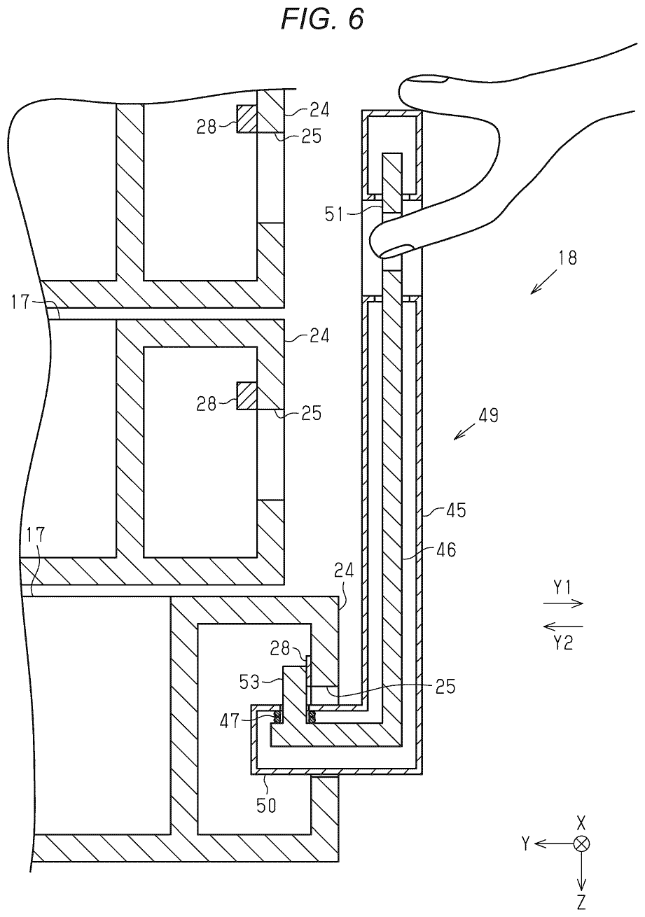

As shown in FIG. 6, the pressing part 53 can press the release lever 28 in the state where the hook part 50 is engaged with the handhold part 25. The pressing part 53 presses the release lever 28 and thus releases the locked state. Therefore, the cassette 17 is moved by being pulled by the assisting tool 18.

### Effects of First Embodiment

The effects of the present embodiment will be described.
(1-1) The assisting tool 18 includes the rod part 49 provided with the hook part 50. The hook part 50 is engageable with the handhold part 25. Therefore, the user can pull out the cassette 17 by engaging the hook part 50 with the handhold part 25 and pulling the rod part 49. That is, the user can move the cassette 17 to the pulled-out position without directly touching the cassette 17. Therefore, the burden on the user when pulling out the cassette 17 from the accommodated position to the pulled-out position can be reduced.
(1-2) The hook part 50 includes the pressing part 53. The pressing part 53 presses the release lever 28 in the state where the hook part 50 is engaged with the handhold part 25. Therefore, even the cassette 17 in the locked state can be released from the locked state and pulled out by the assisting tool 18.
(1-3) The pressing part 53 is movable to the reference position and the release position. The operation lever 51 moves the pressing part 53. As the pressing part 53 is moved by the operation lever 51, the locked state of the cassette 17 can be easily released.
(1-4) The spring 47 energizes the pressing part 53 toward the reference position. Therefore, the pressing part 53 moved from the reference position can be easily returned to the reference position.
(1-5) The assisting tool 18 is engageable with each of one handhold part 25 and another handhold part 25. Therefore, the user can pull out one cassette 17 by engaging the assisting tool 18 with one handhold part 25 without directly touching the one cassette 17.
The user can pull out another cassette 17 by engaging the assisting tool 18 with another handhold part 25 without directly touching the another cassette 17. Therefore, the assisting tool 18 can be shared among the plurality of cassettes 17.

The handhold part 25 may be configured to protrude in the pull-out direction Y1 from the front surface 24. When the handhold part 25 protrudes in the pull-out direction Y1 from the front surface 24, the release lever 28 protrudes in the pull-out direction Y1 from the front surface 24 and is located further in the push-in direction Y2 than the handhold part 25. With this configuration, the user can release the engagement between the lock part 27 and, for example, the housing 12 by pulling the release lever 28 in the pull-out direction Y1. The hook part 50 of the assisting tool 18 can be engaged with the handhold part 25 even in a configuration in which the handhold part 25 protrudes in the pull-out direction Y1 from the front surface 24.
(1-6) The housing 12 includes the accommodation part 20. As the assisting tool 18 is accommodated in the accommodation part 20, the risk of losing the assisting tool 18 can be reduced.

### Second Embodiment

Next, a second embodiment of the assisting tool and the recording device will be described with reference to the drawings. The second embodiment is different from the first embodiment in the assisting tool. Since the other parts of the second embodiment are substantially the same as those of the first embodiment, the same components are denoted by the same reference numerals, and a repeated description thereof will be omitted.

### Assisting Tool

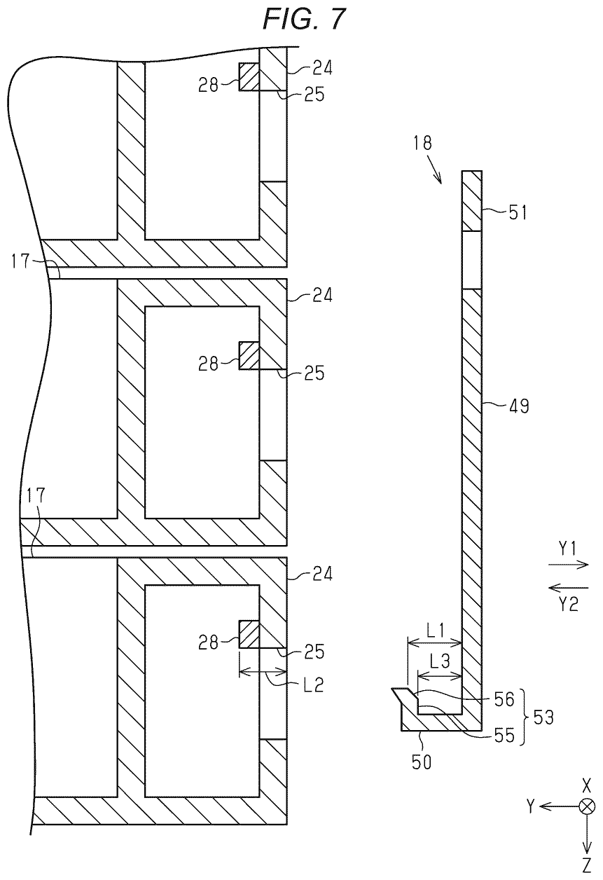

As illustrated in FIG. 7, the assisting tool 18 may include a rod part 49, a hook part 50, and an operation lever 51.

The rod part 49 has a rod shape and extends straight, for example. The rod part 49 may be curved. In the vertical direction Z, the length of the rod part 49 in the engagement posture illustrated in FIG. 7 may be longer than that of the cassette 17.

The operation lever 51 and the hook part 50 are provided at the rod part 49. The operation lever 51 and the hook part 50 are provided away from each other. The hook part 50 may be located at one end of the rod part 49. The operation lever 51 may be located at the other end of the rod part 49.

The hook part 50 is engageable with the handhold part 25. The hook part 50 may include a pressing part 53. The pressing part 53 has a pressing surface 55 and a guide surface 56. The pressing surface 55 may be a surface parallel to the rod part 49. The guide surface 56 is a surface inclined in relation to the pressing surface 55.

In the depth direction Y in the assisting tool 18 in the engagement posture, a first distance L1 from the rod part 49 to the tip of the guide surface 56 is longer than a second distance L2 from the front surface 24 to the tip of the release lever 28. In the depth direction Y in the assisting tool 18 in the engagement posture, a third distance L3 from the rod part 49 to the pressing surface 55 is shorter than the second distance L2.

### Functions of Second Embodiment

The functions of the present embodiment will be described.

The assisting tool 18 assists the pull-out operation of the cassette 17. The assisting tool 18 assists the pull-out operation for each of the plurality of cassettes 17. The hook part 50 is engageable with the handhold part 25 of each of the plurality of cassettes 17.

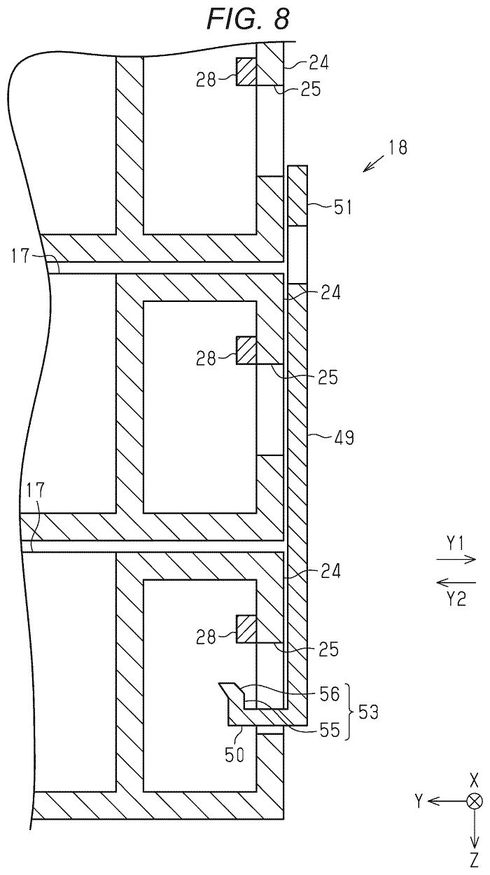

As shown in FIGS. 7 and 8, the hook part 50 of the assisting tool 18 is inserted into the handhold part 25 in the engagement posture.

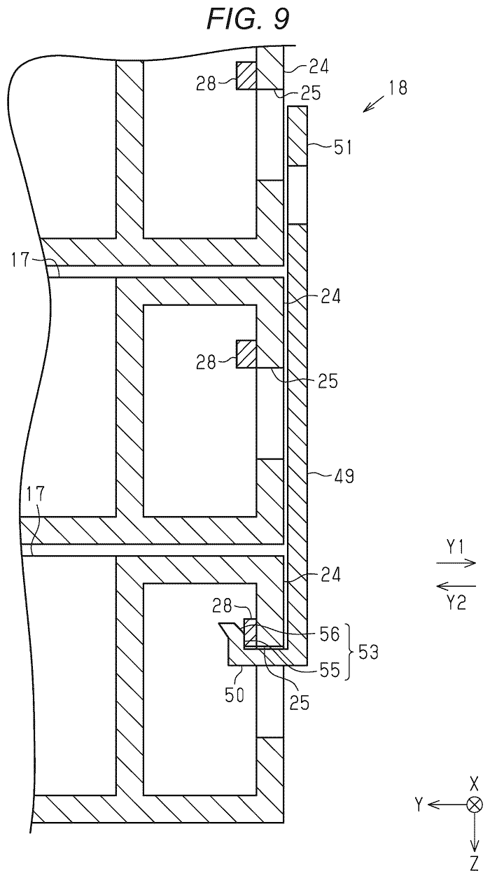

As illustrated in FIG. 9, when the user moves the assisting tool 18 upward in the vertical direction Z, the pressing part 53 presses the release lever 28. That is, the pressing part 53 releases the locked state by the guide surface 56 moving the release lever 28 forward and the pressing surface 55 holding the release lever 28 in the pressed state. Therefore, when the user pulls the assisting tool 18 in the pull-out direction Y1, the cassette 17 is pulled out.

### Effects of Second Embodiment

The effects of the present embodiment will be described.
(2-1) The hook part 50 includes the pressing part 53. When the assisting tool 18 is moved upward, the pressing part 53 presses the release lever 28 and thus releases the locked state. Therefore, the locked state can be released and the cassette 17 can be pulled out by the assisting tool 18.

### Modification Examples

The present embodiments can be implemented with the modifications described below. The present embodiments and the modification examples given below can be implemented in combination with each other as long as no technical inconsistencies are involved.

### First Modification Example

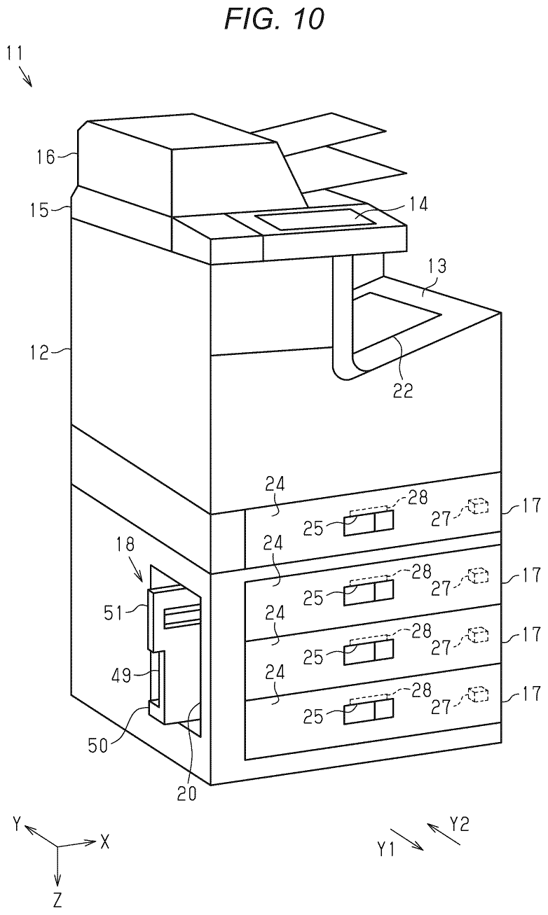

As shown in FIG. 10, the assisting tool 18 accommodated in the accommodation part 20 may partially protrude from the accommodation part 20. As a part of the assisting tool 18 is located outside the accommodation part 20, the assisting tool 18 can be easily taken out of the accommodation part 20.

### Second Modification Example

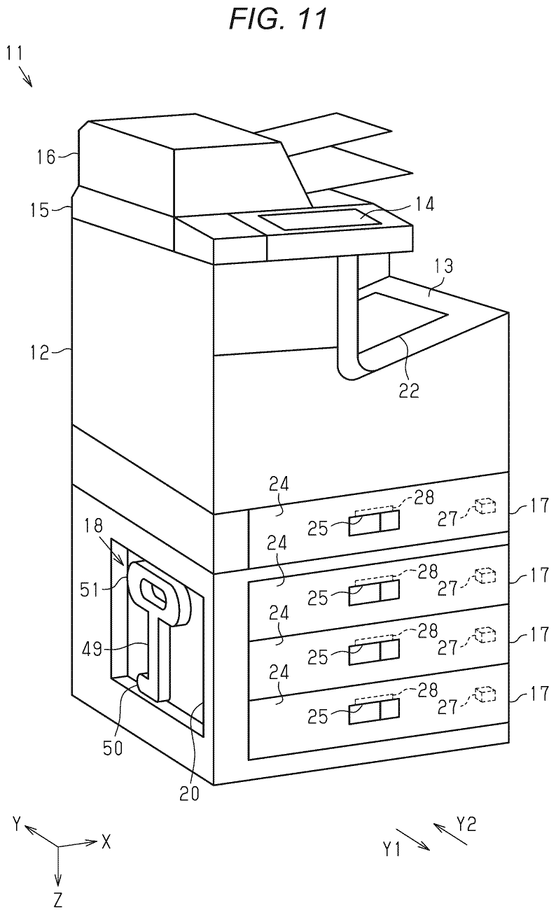

As illustrated in FIG. 11, in the assisting tool 18, the direction in which the operation lever 51 extends and the direction in which the hook part 50 protrudes from the rod part 49 may be the same direction.

### Other Modification Examples

The assisting tool 18 may assist the push-in operation.

The accommodation part 20 may be a recess along the outer shape of the assisting tool 18. The shape of the accommodation part 20 may be aligned with the shape of the assisting tool 18.

The release lever 28 is not limited to the configuration provided on the handhold part 25. The release lever 28 may be provided at a location different from the handhold part 25, or may be provided at both a location different from the handhold part 25 and the handhold part 25. The release lever 28 provided at a location different from the handhold part 25 may be released by the assisting tool 18. Also, the cassette 17 may be configured to be able to be pulled out by releasing either one of the release lever 28 provided at a position different from the handhold part 25 and the release lever 28 provided at the handhold part 25 by the assisting tool 18.

The accommodation part 20 may be a hook that catches the assisting tool 18.

One of the accommodation part 20 and the assisting tool 18 may include a magnet, and the other may include a magnet or a magnetic body. The accommodation part 20 may hold the assisting tool 18 by a magnetic force.

The accommodation part 20 may be a table where the assisting tool 18 is placed.

The accommodation part 20 may be a pocket in which the assisting tool 18 is inserted.

The accommodation part 20 may be provided in the housing 12.

The accommodation part 20 may include a cover. The assisting tool 18 may be able to be taken out by opening the cover. The accommodation part 20 may be provided behind the cover.

The accommodation part 20 may be provided in the cassette 17. For example, it is more difficult to pull out the cassette 17 located below than the cassette 17 located above. Therefore, for example, the accommodation part 20 may be provided in the cassette 17 located above. When pulling out the cassette 17 located below, the user may take out the assisting tool 18 from the cassette 17 located above and use the assisting tool 18.

The housing 12 may not include the accommodation part 20. The assisting tool 18 may be provided separately from the recording device 11.

The number of cassettes 17 provided in the recording device 11 may be one.

The recording device 11 may include a plurality of assisting tools 18. For example, one assisting tool 18 may correspond to one cassette 17.

The spring 47 may be an extension spring that pulls the pressing part 53 located at the release position toward the reference position.

In the second embodiment, the assisting tool 18 may not include the operation lever 51.

The cassette 17 may not include the lock part 27 or the release lever 28. In this case, the assisting tool 18 may not include the pressing part 53.

The recording device 11 is not limited to an inkjet printer, and may be a laser printer, a thermal printer, a dot impact printer, a digital printing machine, or the like.

The recording device 11 may be a liquid-jet device that jets or ejects a liquid other than ink and thus performs recording. The state of the liquid ejected as a very small amount of droplet from the liquid-jet device includes a particle state, a tear-drop state, and a state where a tail is drawn in a thread shape. The liquid mentioned here may be any material that can be jetted from the liquid-jet device. For example, the liquid is only required to be in a liquid phase of a substance, and includes a liquid material high or low in viscosity, sol, gel water, other inorganic solvents, organic solvents, solutions, and fluid materials such as liquid resin, liquid metal, and metal melt. The liquid includes not only a liquid as a state of a substance but also a liquid formed of particles of a functional material made of a solid matter such as a pigment or a metal particle that are dissolved, dispersed, or mixed in a solvent. Representative examples of the liquid include the ink as described in the above embodiments, and a liquid crystal or the like. The term ink includes various types of liquid compositions such as general water-based ink, oil-based ink, gel ink, and hot melt ink. As a specific example of the liquid-jet device, there is a device that jets a liquid containing a material such as an electrode material or a coloring material used, for example, for manufacturing a liquid crystal display, an electroluminescence display, a surface-emitting display, and a color filter, in a dispersed or dissolved form. The liquid-jet device may be a device that jets a bioorganic substance used for manufacturing a biochip, a device that is used as a precision pipette and jets a liquid serving as a sample, a textile printing device, a micro dispenser, or the like. The liquid-jet device can be a device that jets lubricating oil to a precision machine such as a timepiece or a camera in a pinpoint manner, or a device that jets a transparent resin liquid such as an ultraviolet curable resin onto a substrate in order to form a minute hemispherical lens, an optical lens, or the like used for an optical communication element or the like. The liquid jet device may be a device that jets an acid or alkali etching solution or the like in order to etch a substrate or the like.

### Definition

The expression “at least one” used in this specification means “one or more” of desired alternatives. For example, the expression “at least one” used in the present specification means “only one alternative” or “both of two alternatives” when the number of alternatives is two. As another example, the expression “at least one” used in the present specification means “only one alternative”, “a combination of any two alternatives”, or “a combination of any three or more alternatives” when the number of alternatives is three or more.

### Appendices

Technical ideas understood from the embodiments and the modification examples described above, and the advantageous effects thereof will be described below.
[1] An assisting tool assists a pull-out operation of a cassette configured to be able to advance and retreat in relation to a housing between an accommodated position where the cassette is accommodated in the housing and a pulled-out position where the cassette is pulled out from the housing, and the cassette is formed with a handhold part recessed in a direction opposite to a pull-out direction from a surface intersecting the pull-out direction, and the assisting tool includes a rod part, and a hook part provided at the rod part and engageable with the handhold part.

With this configuration, the assisting tool includes the rod part provided with the hook part. The hook part is engageable with the handhold part. Therefore, the user can pull out the cassette by engaging the hook part with the handhold part and pulling the rod part. That is, the user can move the cassette to the pulled-out position without directly touching the cassette. Therefore, the burden on the user when pulling out the cassette from the accommodated position to the pulled-out position can be reduced.
[2] In the assisting tool according to the above [1], the cassette may include a release lever for releasing a locked state where movement from the accommodated position is restricted, and the hook part may include a pressing part configured to be able to press the release lever in a state of being engaged with the handhold part.

With this configuration, the hook part includes the pressing part. The pressing part presses the release lever in the state where the hook part is engaged with the handhold part. Therefore, even the cassette in the locked state can be pulled out by the assisting tool releasing the locked state.
[3] In the assisting tool according to the above [2], the pressing part may be movable to a reference position where the pressing part does not press the release lever and a release position where the pressing part presses the release lever, in a state where the hook part is engaged with the handhold part, and the assisting tool may further include an operation lever configured to move the pressing part.

With this configuration, the pressing part is movable to the reference position and the release position. The operation lever moves the pressing part. As the pressing part is moved by the operation lever, the locked state of the cassette can be easily released.
[4] The assisting tool according to the above [3] may further include a spring configured to energize the pressing part located at the release position toward the reference position.

With this configuration, the spring energizes the pressing part toward the reference position. Therefore, the pressing part moved from the reference position can be easily returned to the reference position.
[5] A recording device includes a housing, a cassette configured to be able to advance and retreat in relation to the housing between an accommodated position where the cassette is accommodated in the housing and a pulled-out position where the cassette is pulled out from the housing, the cassette being configured to be able to accommodate a plurality of media, a recording unit configured to perform recording on the media conveyed from the cassette, and an assisting tool configured to assist a pull-out operation of the cassette, and the cassette is formed with a handhold part recessed in a direction opposite to a pull-out direction from a surface intersecting the pull-out direction, and the assisting tool includes a rod part, and a hook part provided in the rod part and engageable with the handhold part. With this configuration, effects similar to those of the assisting tool can be achieved.
[6] In the recording device according to the above [5], the cassette may include a release lever for releasing a locked state where movement from the accommodated position is restricted, and the hook part may include a pressing part configured to be able to press the release lever in a state of being engaged with the handhold part. With this configuration, effects similar to those of the assisting tool can be achieved.
[7] In the recording device according to the above [6], the pressing part may be movable to a reference position where the pressing part does not press the release lever and a release position where the pressing part presses the release lever, in a state where the hook part is engaged with the handhold part, and the assisting tool may further include an operation lever configured to move the pressing part. With this configuration, effects similar to those of the assisting tool can be achieved.
[8] In the recording device according to the above [7], the assisting tool may further include a spring configured to energize the pressing part located at the release position toward the reference position. With this configuration, effects similar to those of the assisting tool can be achieved.
[9] The recording device according to any one of the above [5] to [8] may further include a second cassette configured to advance and retreat in relation to the housing between an accommodated position where the second cassette is accommodated in the housing and a pulled-out position where the second cassette is pulled out from the housing, when the cassette is defined as a first cassette and the handhold part is defined as a first handhold part, and the second cassette may be formed with a second handhold part recessed in a direction opposite to the pull-out direction from a surface intersecting the pull-out direction, and the hook part may be engageable with the second handhold part.

With this configuration, the assisting tool is engageable with each of the first hand hooking part and the second hand hooking part. Therefore, the user can pull out the first cassette by engaging the assisting tool with the first hand-holding part without directly touching the first cassette. The user can pull out the second cassette by engaging the assisting tool with the second hand-holding part without directly touching the second cassette. Therefore, the assisting tool can be shared among the plurality of cassettes.
[10] In the recording device according to any one of the above [5] to [9], the housing may include an accommodation part configured to accommodate the assisting tool.

With this configuration, the housing includes the accommodation part. As the assisting tool is accommodated in the housing part, the risk of losing the assisting tool can be reduced.

What is claimed is:

1. An assisting tool that assists a pull-out operation of a cassette configured to be able to advance and retreat in relation to a housing between an accommodated position where the cassette is accommodated in the housing and a pulled-out position where the cassette is pulled out from the housing,
the cassette being formed with a handhold part recessed in a direction opposite to a pull-out direction from a surface intersecting the pull-out direction,
the assisting tool comprising:
a rod part; and
a hook part provided at the rod part and engageable with the handhold part.

2. The assisting tool according to claim 1, wherein
the cassette includes a release lever for releasing a locked state where movement from the accommodated position is restricted, and
the hook part includes a pressing part configured to be able to press the release lever in a state of being engaged with the handhold part.

3. The assisting tool according to claim 2, wherein
the pressing part is movable to a reference position where the pressing part does not press the release lever and a release position where the pressing part presses the release lever, in a state where the hook part is engaged with the handhold part, and
the assisting tool further comprises an operation lever configured to move the pressing part.

4. The assisting tool according to claim 3, further include a spring configured to energize the pressing part located at the release position toward the reference position.

5. A recording device comprising:
a housing;
a cassette configured to be able to advance and retreat in relation to the housing between an accommodated position where the cassette is accommodated in the housing and a pulled-out position where the cassette is pulled out from the housing, the cassette being configured to be able to accommodate a plurality of media;
a recording unit configured to perform recording on the media conveyed from the cassette; and
an assisting tool configured to assist a pull-out operation of the cassette, wherein
the cassette is formed with a handhold part recessed in a direction opposite to a pull-out direction from a surface intersecting the pull-out direction, and
the assisting tool includes
a rod part, and
a hook part provided in the rod part and engageable with the handhold part.

6. The recording device according to claim 5, wherein
the cassette includes a release lever for releasing a locked state where movement from the accommodated position is restricted, and
the hook part includes a pressing part configured to be able to press the release lever in a state of being engaged with the handhold part.

7. The recording device according to claim 6, wherein
the pressing part is movable to a reference position where the pressing part does not press the release lever and a release position where the pressing part presses the release lever, in a state where the hook part is engaged with the handhold part, and
the assisting tool further includes an operation lever configured to move the pressing part.

8. The recording device according to claim 7, wherein
the assisting tool further includes a spring configured to energize the pressing part located at the release position toward the reference position.

9. The recording device according to claim 8, further comprising:
when the cassette is defined as a first cassette and the handhold part is defined as a first handhold part,
a second cassette configured to advance and retreat in relation to the housing between an accommodated position where the second cassette is accommodated in the housing and a pulled-out position where the second cassette is pulled out from the housing, wherein
the second cassette is formed with a second handhold part recessed in a direction opposite to the pull-out direction from the surface intersecting the pull-out direction, and
the hook part is engageable with the second handhold part.

10. The recording device according to claim 5, wherein
the housing includes an accommodation part configured to accommodate the assisting tool.
